(19) United States
(12) Patent Application Publication
(10) Pub. No.: US 2018/0158598 A1
(43) Pub. Date: Jun. 7, 2018

(54) IMBALANCED MAGNETIC-CANCELLING COILS

(71) Applicant: GEAR RADIO ELECTRONICS CORP., Hsinchu City (TW)

(72) Inventors: Min-Chiao Chen, Kaohsiung City (TW); Tao-Yi Lee, Taichung City (TW); Tsung-Ling Li, Hsinchu City (TW)

(21) Appl. No.: 15/435,240

(22) Filed: Feb. 16, 2017

Related U.S. Application Data
(60) Provisional application No. 62/430,876, filed on Dec. 6, 2016.

(51) Int. Cl. H01F 27/34; H01F 27/29; H01F 27/28

(52) U.S. Cl. CPC H01F 27/34; H01F 27/2823; H01F 27/29

(57) ABSTRACT

An inductor equipped with imbalanced magnetic-cancelling (IMC) architecture and an associated apparatus are provided. The inductor may include a first terminal, a second terminal, and a plurality of partial wirings coupled between the first terminal and the second terminal. The plurality of partial wirings may include a first set of partial wirings coupled in series and coupled to the first terminal, a second set of partial wirings coupled in series and coupled to the second terminal, and a third set of partial wirings coupled in series and coupled between the first set of partial wirings and the second set of partial wirings. Additionally, a second area enclosed by the first set of partial wirings and the second set of partial wirings is different from a first area enclosed by the third set of partial wirings, to provide the inductor with the IMC architecture.

### CROSS REFERENCE TO RELATED APPLICATIONS

This application claims the benefit of U.S. Provisional Application No. 62/430,876, which was filed on Dec. 6, 2016, and is included herein by reference.

### BACKGROUND OF THE INVENTION

### 1. Field of the Invention

The present invention relates to performance enhancement of integrated circuits (ICs), and more particularly, to an inductor equipped with imbalanced magnetic-cancelling (IMC) architecture, and an associated apparatus.

### 2. Description of the Prior Art

Some solutions are proposed for reducing the mutual electromagnetic (EM) coupling between components due to inductors. However, some problems such as side effects may occur. For example, these solutions typically require additional circuitry (e.g. dividers, mixers, etc.) that may increase current consumption. In addition, some inductor designs for reducing mutual EM coupling are proposed. When somebody implements an electronic product according to one or more of these inductor designs, the electronic product may encounter some side effects such as some inherent deficiencies due to the inductor designs. Thus, there is a need for a novel architecture to properly solve the existing problems without introducing unwanted side effects, or in a way that is less likely to introduce a side effect.

### SUMMARY OF THE INVENTION

An objective of the present invention is to provide an inductor equipped with imbalanced magnetic-cancelling (IMC) architecture, and an associated apparatus, in order to solve the problems of the related arts.

Another objective of the present invention is to provide an inductor equipped with IMC architecture, and an associated apparatus, in order to enhance performance of integrated circuits (ICs).

At least one embodiment of the present invention provides an inductor equipped with IMC architecture, where the inductor is applicable to an electronic device. The inductor may comprise a first terminal, a second terminal, and a plurality of partial wirings coupled between the first terminal and the second terminal. The first terminal may be arranged to couple the inductor to a terminal of a circuit of the electronic device. The second terminal maybe arranged to couple the inductor to another terminal of the circuit of the electronic device. For example, the plurality of partial wirings may comprise a first set of partial wirings which may be coupled in series, a second set of partial wirings which may be coupled in series, and a third set of partial wirings which may be coupled in series. The first set of partial wirings may be coupled to the first terminal of the inductor. The second set of partial wirings may be coupled to the second terminal of the inductor. The third set of partial wirings may be coupled between the first set of partial wirings and the second set of partial wirings. Additionally, a second area enclosed by the first set of partial wirings and the second set of partial wirings is different from a first area enclosed by the third set of partial wirings, to provide the inductor with the IMC architecture.

At least one embodiment of the present invention provides an apparatus for performing magnetic-cancelling, where the apparatus is applicable to an electronic device. The apparatus may comprise an inductor equipped with IMC architecture. The inductor may comprise a first terminal, a second terminal, and a plurality of partial wirings coupled between the first terminal and the second terminal. The first terminal may be arranged to couple the inductor to a terminal of a circuit of the electronic device. The second terminal maybe arranged to couple the inductor to another terminal of the circuit of the electronic device. For example, the plurality of partial wirings may comprise a first set of partial wirings which may be coupled in series, a second set of partial wirings which may be coupled in series, and a third set of partial wirings which may be coupled in series. The first set of partial wirings may be coupled to the first terminal of the inductor. The second set of partial wirings may be coupled to the second terminal of the inductor. The third set of partial wirings may be coupled between the first set of partial wirings and the second set of partial wirings. Additionally, a second area enclosed by the first set of partial wirings and the second set of partial wirings is different from a first area enclosed by the third set of partial wirings, to provide the inductor with the IMC architecture. In some embodiments, the apparatus may comprise at least one portion (e.g. a portion or all) of the electronic device. For example, the apparatus may comprise the circuit of the electronic device. For another example, the apparatus may comprise the whole of the electronic device.

The present invention inductor and apparatus may solve problems existing in the related arts without introducing unwanted side effects, or in a way that is less likely to introduce a side effect. When implementing an electronic product according to the present invention inductor and apparatus, one will not suffer from the problems existing in the related arts. For example, the present invention inductor may be configured to reduce or cancel electromagnetic (EM) interference (e.g. unwanted magnetic coupling) due to a neighboring coil such as a coil positioned near the present invention inductor, no matter where this coil is positioned and no matter whether this coil is positioned on any axis of the present invention inductor (e.g. any axis of symmetry thereof, or any reference axis thereof) or not. In some examples, the neighboring coil may be adjacent to the present invention inductor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an inductor equipped with imbalanced magnetic-cancelling (IMC) architecture according to an embodiment of the present invention.

FIG. 2 is a diagram of an inductor equipped with IMC architecture according to another embodiment of the present invention.

FIG. 3 illustrates an off-axis IMC control scheme of an inductor equipped with IMC architecture according to an embodiment of the present invention, where the inductor shown in FIG. 3 can be taken as an example of the inductor shown in FIG. 1.

FIG. 4 illustrates an on-axis IMC control scheme of the inductor shown in FIG. 3 according to an embodiment of the present invention.

FIG. 5 illustrates an even-turn IMC (ETIMC) control scheme of an inductor equipped with IMC architecture according to an embodiment of the present invention, where the inductor shown in FIG. 5 can be taken as an example of the inductor shown in FIG. 2.

FIG. 6 illustrates an electromagnetic (EM) simulation setup of an inductor equipped with IMC architecture according to an embodiment of the present invention, where the inductor shown in FIG. 6 can be taken as an example of the inductor shown in FIG. 2.

FIG. 7 illustrates a first layer of a first ETIMC inductor mask design according to an embodiment of the present invention.

FIG. 8 illustrates a second layer of the first ETIMC inductor mask design.

FIG. 9 illustrates a third layer of the first ETIMC inductor mask design.

FIG. 10 illustrates a first layer of a second ETIMC inductor mask design according to another embodiment of the present invention.

FIG. 11 illustrates a second layer of the second ETIMC inductor mask design.

FIG. 12 illustrates a third layer of the second ETIMC inductor mask design.

FIG. 13 is a diagram of an inductor equipped with IMC architecture according to another embodiment of the present invention.

### DETAILED DESCRIPTION

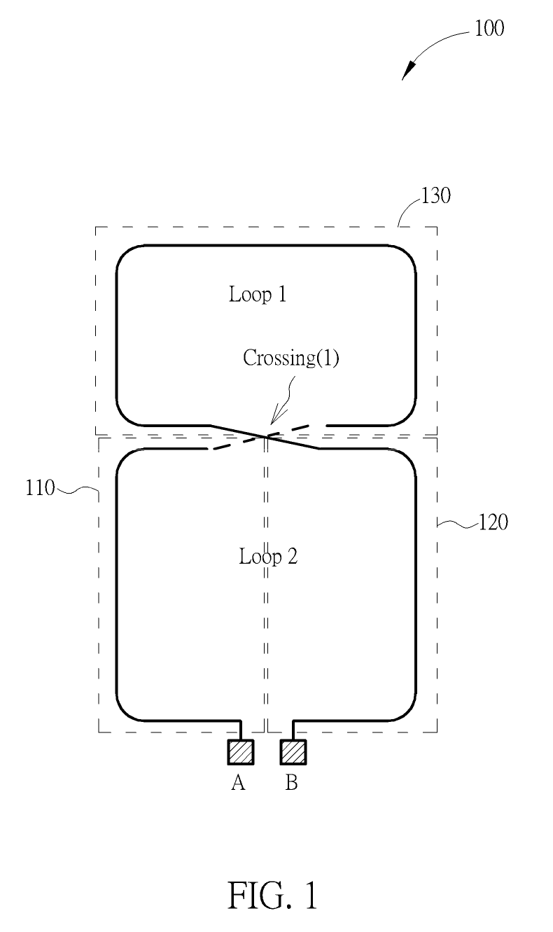

FIG. 1 is a diagram of an inductor 100 equipped with imbalanced magnetic-cancelling (IMC) architecture according to an embodiment of the present invention. The inductor 100 is applicable to an electronic device. For example, the inductor 100 may be applied to an integrated circuit (IC) in the electronic device, and the inductor 100 may be implemented as one of multiple components within the IC. The inductor 100 is capable of reducing or cancelling electromagnetic (EM) interference (e.g. unwanted magnetic coupling) due to a neighboring coil such as a coil positioned near the inductor 100 within the electronic device. According to some embodiments, the neighboring coil may be adjacent to the present invention inductor such as the inductor 100. Examples of the IC may include, but not limited to, Bluetooth transceiver front-ends, Wi-Fi (IEEE 802.11 family, including, but not limited to, a/b/g/n/ac) transceiver front-ends, cellular transceiver front-ends, DVB (digital video broadcasting) transceiver front-ends, DAB (digital audio broadcasting) transceiver front-ends, and any of other types of RFIC (radio frequency IC) transceiver front-ends.

As shown in FIG. 1, the inductor 100 may comprise terminals such as a first terminal A and a second terminal B, and may comprise a plurality of partial wirings coupled between the first terminal A and the second terminal B, such as at least one electrical conductor (e.g. one or more electrical conductors) having partial structures of wirings on one or more conduction paths between the first terminal A and the second terminal B within the inductor 100. The first terminal A may be arranged to couple the inductor 100 to a terminal of a circuit (e.g. the IC) of the electronic device, and the second terminal B may be arranged to couple the inductor 100 to another terminal of the circuit of the electronic device. As a result, the circuit may utilize the inductor 100 as one of the components of the circuit. In addition, the plurality of partial wirings may comprise a first set of partial wirings 110 which may be coupled in series, a second set of partial wirings 120 which may be coupled in series, and a third set of partial wirings 130 which may be coupled in series. The first set of partial wirings 110 may be coupled to the first terminal A of the inductor 100, and the second set of partial wirings 120 may be coupled to the second terminal B of the inductor 100. The third set of partial wirings 130 may be coupled between the first set of partial wirings 110 and the second set of partial wirings 120. Additionally, the plurality of partial wirings such as the aforementioned at least one electrical conductor may be arranged to have the shape of two loops such as that labeled “Loop 1” and “Loop 2” in FIG. 1, respectively, and a second area enclosed by the first set of partial wirings 110 and the second set of partial wirings 120 (e.g. the area enclosed by the loop labeled “Loop 2” in FIG. 1) is different from a first area enclosed by the third set of partial wirings 130 (e.g. the area enclosed by the loop labeled “Loop 1” in FIG. 1), to provide the inductor 100 with the IMC architecture.

According to this embodiment, one end of the first set of partial wirings 110 (e.g. the lower end thereof) is connected to the first terminal A of the inductor 100, and one end of the second set of partial wirings 120 (e.g. the lower end thereof) is connected to the second terminal B of the inductor 100. The third set of partial wirings 130 is coupled between another end of the first set of partial wirings 110 (e.g. the upper end thereof) and another end of the second set of partial wirings 120 (e.g. the upper end thereof). Please note that some partial wirings near the crossing point Crossing(1) may be illustrate with dashed lines to clearly indicate a specific partial path corresponding to these partial wirings and another partial path corresponding to some other partial wirings near these partial wirings, respectively, in order to prevent confusion. At the crossing point Crossing(1), the specific partial path and the other partial path are not electrically connected to each other. For example, a current path within the inductor 100 may start from the first terminal A and pass through the first set of partial wirings 110, and may reach the right half of the third set of partial wirings 130 at the crossing point Crossing(1) and pass through the third set of partial wirings 130, and may further reach the second set of partial wirings 120 at the crossing point Crossing(1), pass through the second set of partial wirings 120 and reach the second terminal B.

The architecture shown in FIG. 1 may be regarded as an inductor architecture having the two loops of different sizes and one crossing point (e.g. the crossing point Crossing(1)). For the loop labeled “Loop 2” in FIG. 1, although there is not any direct electrical connection between the first set of partial wirings 110 and the second set of partial wirings 120 at the crossing point Crossing(1), it looks like a loop when seen from a normal direction of FIG. 1 (e.g. a direction that is parallel to the Z-axis, in a situation where FIG. 1 is on the X-Y plane having the X-axis and the Y-axis), and therefore may be referred to as the loop, regardless of the crossing point Crossing(1). According to some embodiments, the present invention inductor (e.g. the inductor 100, etc.) may be implemented on the circuit such as the IC, where a substrate for implementing the IC may be on the X-Y plane, and the normal direction of the substrate may be parallel to the Z-axis. For example, one or more sets of partial wirings having break point(s) and/or crossing point(s) look like a loop when seen from the normal direction of the substrate, and therefore the one or more sets of partial wirings may be referred to as the loop, regardless of whether the break point(s) and/or crossing point(s) exist or not. In some embodiments, one or more sets of partial wirings may be similar to that of the loop labeled “Loop 2” in FIG. 1, and may also be referred to as a loop.

According to some embodiments, as the second area (e.g. the area enclosed by the loop labeled “Loop 2” in FIG. 1) is different from the first area (e.g. the area enclosed by the loop labeled “Loop 1” in FIG. 1), the inductor 100 is capable of performing magnetic-cancelling in an imbalanced manner to minimize unwanted magnetic coupling, no matter where an aggressor coil (e.g. the neighboring coil mentioned above) is positioned and no matter whether the aggressor coil is positioned on any axis of the inductor 100 (e.g. any axis of symmetry thereof, or any reference axis thereof) or not.

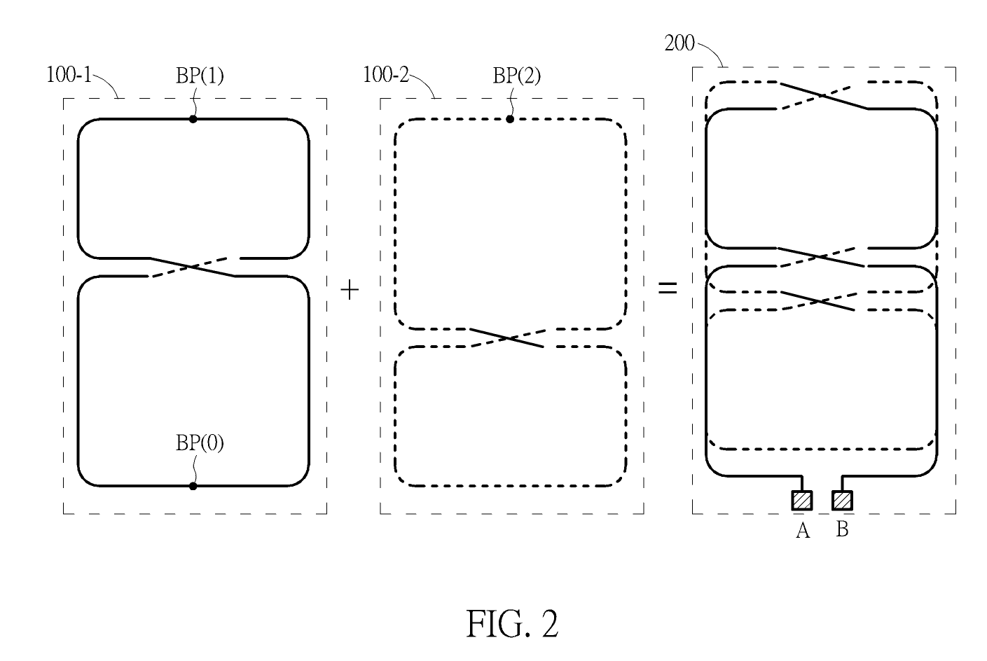

FIG. 2 is a diagram of an inductor 200 equipped with IMC architecture according to another embodiment of the present invention. For better comprehension, two closed loop versions 100-1 and 100-2 of the inductor 100 are illustrated, where each of the two closed loop versions 100-1 and 100-2 may be regarded as one turn, and some break points such as the break points BP(0), BP(1), BP(2), etc. may indicate that the loop(s)/turn(s) may be broken there. As shown in FIG. 2, the inductor 200 may be implemented by combining the two closed loop versions 100-1 and 100-2 of the inductor 100. Suppose that the closed loop version 100-1 of the inductor 100 may be broken at the break points BP(0) and BP(1) into two portions, such as an S-shape portion and an inverse-S-shape portion, and that the closed loop version 100-2 of the inductor 100 may be broken at the break point BP(2). The inductor 200 is equivalent to a combination of the inverse-S-shape portion of the closed loop version 100-1, the closed loop version 100-2 that has been broken at the break point BP(2), and the S-shape portion of the closed loop version 100-1. For example, a current path within the inductor 200 may start from the first terminal A and pass through the inverse-S-shape portion integrated into the inductor 200 (e.g. starting from the lower end of the inverse-S-shape portion at the break point BP(0) and reaching the upper end of the inverse-S-shape portion at the break point BP(1)), and may pass through the closed loop version 100-2 that has been broken at the break point BP(2) and is integrated into the inductor 200 (e.g. starting from one end at the left side of the break point BP(2) and reaching the other end at the right side of the break point BP(2)), and may further pass through the S-shape portion integrated into the inductor 200 (e.g. starting from the upper end of the S-shape portion at the break point BP(1) and reaching the lower end of the S-shape portion at the break point BP(0)) and reach the second terminal B.

The architecture shown in FIG. 2 maybe regarded as an inductor architecture having even turns of inductor architecture. As there are even turns, and as each turn of the even turns corresponds to the IMC architecture of the inductor 100, the IMC architecture of the inductor 200 may be referred to as the even-turn IMC (ETIMC) architecture. While the inductor 100 equipped with the IMC architecture may be regarded as an IMC inductor, the inductor 200 equipped with the IMC architecture may be regarded as an ETIMC inductor. Please note that the inductor 200 is also applicable to an electronic device such as that mentioned above. For example, the inductor 200 may be applied to the IC in the electronic device, and the inductor 200 may be implemented as one of multiple components within the IC. Because of the ETIMC architecture, the inductor 200 can greatly reduce or cancel unwanted magnetic coupling due to a neighboring coil such as that mentioned above.

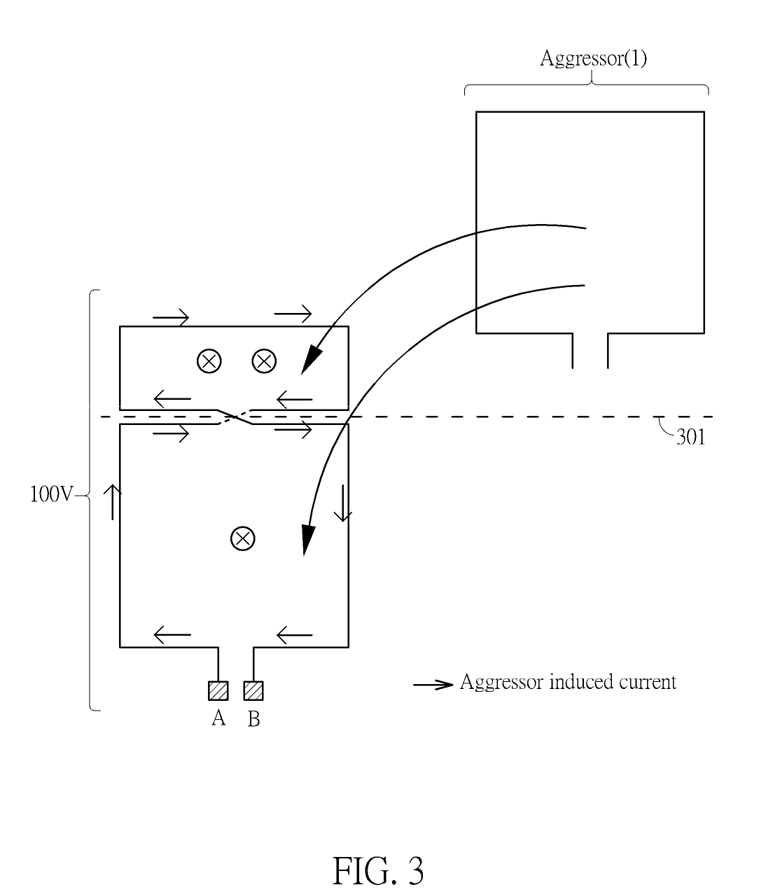

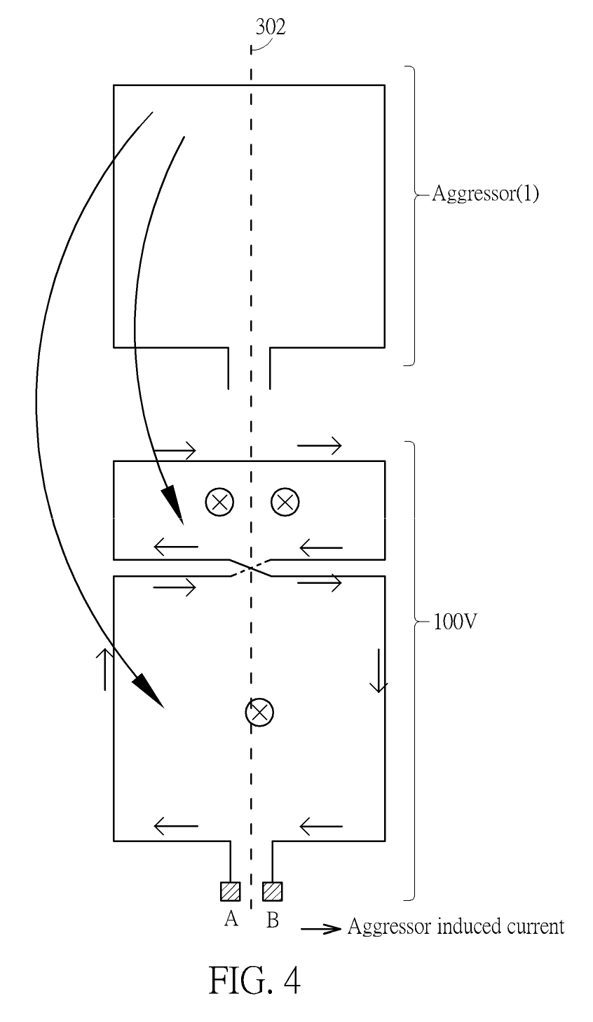

FIG. 3 illustrates an off-axis IMC control scheme of an inductor 100V equipped with IMC architecture according to an embodiment of the present invention, where the inductor 100V shown in FIG. 3 can be taken as an example of the inductor 100 shown in FIG. 1. The axis 301 of the inductor 100V passes through the crossing point of the inductor 100V. For example, the axis 301 may be parallel to a horizontal axis such as the X axis. According to this embodiment, the second area (e.g. the area enclosed by the loop labeled “Loop 2” in FIG. 1) such as the area enclosed by the partial wirings below the axis 301 is still different from the first area (e.g. the area enclosed by the loop labeled “Loop 1” in FIG. 1) such as the area enclosed by the partial wirings above the axis 301. The IMC architecture of the inductor 100V works when the aggressor coil (e.g. the neighboring coil) such as the aggressor coil Aggressor(1) shown in FIG. 3 (more specifically, the center of the aggressor coil Aggressor(1)) does not lie on an axis of the inductor 100V (e.g. the axis 301 shown in FIG. 3, or the axis 302 shown in FIG. 4). The aggressor induced currents (e.g. the induced currents illustrated with the arrows along the current path of the inductor 100V) may correspond to the magnetic fields at the first area and the second area, respectively. As the relative location of the aggressor coil Aggressor(1) with respect to the inductor 100V may be determined in advance (e.g. in a design phase of the electronic device), the sizes of the first area and the second area may be determined in advance (e.g. in the same design phase of the electronic device) to minimize unwanted magnetic coupling due to the aggressor coil Aggressor(1). For example, as the distance between the aggressor coil Aggressor(1) and the center of the second area (e.g. the center of the area enclosed by the partial wirings below the axis 301) is greater than the distance between the aggressor coil Aggressor(1) and the center of the first area (e.g. the area enclosed by the partial wirings above the axis 301), the magnet field caused by the aggressor coil Aggressor(1) in the first area is stronger than that in the second area (e.g. it is illustrated that the density of the symbol “⊗” above the axis 301 is higher than that of the symbol “⊗” below the axis 301, for indicating that the magnetic flux density in the first area is higher than that in the second area). As a result of properly designing the sizes of the first area and the second area, the second area is greater than the first area. For example, the total induced current corresponding to the second area (e.g. the total induced current on the partial wirings below the axis 301) may be equal to the total induced current corresponding to the first area (e.g. the total induced current on the partial wirings above the axis 301), and therefore they may cancel each other. In some examples, the sizes of the first area and the second area may be roughly determined, and the total induced current corresponding to the second area may be almost equal to that corresponding to the first area, and therefore they may almost cancel each other.

FIG. 4 illustrates an on-axis IMC control scheme of the inductor 100V shown in FIG. 3 according to an embodiment of the present invention. The axis 302 of the inductor 100V passes through the crossing point of the inductor 100V. For example, the axis 302 may be parallel to a vertical axis such as the Y axis, where the axis 302 of this embodiment may be regarded as an axis of symmetry of the inductor 100V. Please note that the IMC architecture of the inductor 100V also works when the aggressor coil (e.g. the neighboring coil) such as the aggressor coil Aggressor(1) shown in FIG. 4 (more specifically, the center of the aggressor coil Aggressor(1)) lies on the axis 302. Similarly, as a result of properly designing the sizes of the first area and the second area, the second area is greater than the first area. For example, the total induced current corresponding to the second area may be equal to that corresponding to the first area, and therefore they may cancel each other. In some examples, the sizes of the first area and the second area may be roughly determined, and the total induced current corresponding to the second area may be almost equal to that corresponding to the first area, and therefore they may almost cancel each other.

Regarding the off-axis IMC control scheme and the on-axis IMC control scheme, implementation of the determination of the sizes of the first area and the second area may vary. In some embodiments, the sizes of the first area and the second area may be determined by performing one or more simulations based on an IMC inductor model of the inductor 100V and an aggressor coil model of the aggressor coil Aggressor(1). In some embodiments, the sizes of the first area and the second area may be determined based on a trial and error method.

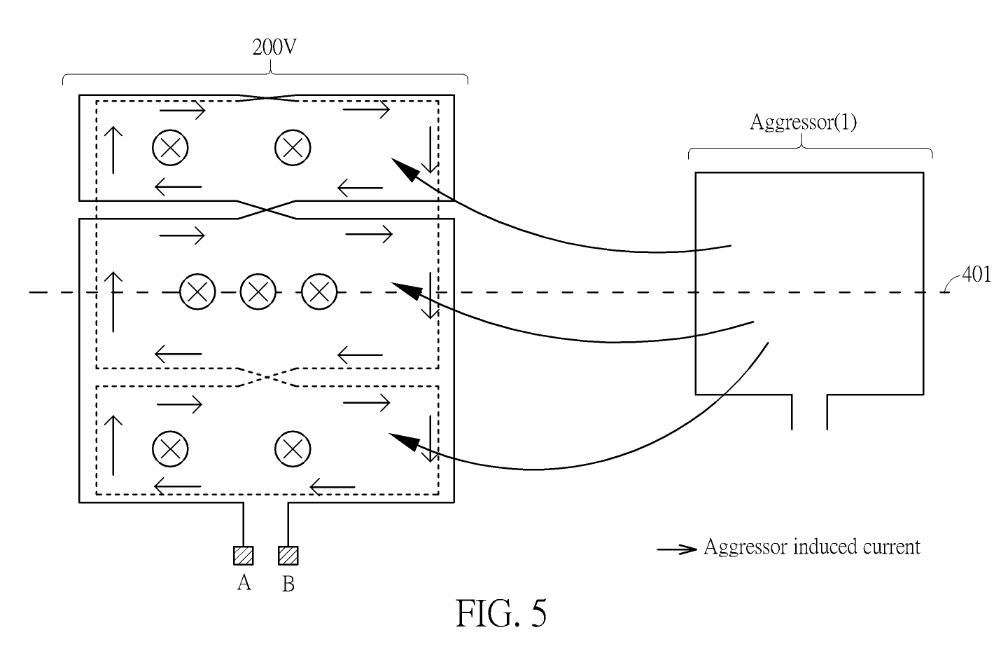

FIG. 5 illustrates an ETIMC control scheme of an inductor 200V equipped with IMC architecture according to an embodiment of the present invention, where the inductor 200V shown in FIG. 5 can be taken as an example of the inductor 200 shown in FIG. 2. Two axes of the inductor 200V, such as the axis 401 and another axis of the inductor 200V (e.g. the axis 402 shown in one or more of the following embodiments) that are perpendicular to each other, pass through the center (e.g. the center of symmetry of the inductor 200V). For example, one of the two axes of the inductor 200V (e.g. the axis 401) may be parallel to a horizontal axis such as the X axis, and the other of the two axes of the inductor 200V (e.g. the axis 402) may be parallel to a vertical axis such as the Y axis. When neglecting some minor differences of implementation details regarding layout (such as that due to a small gap between the terminals A and B and/or a small shift of one or more partial wirings), each of the axes 401 and 402 of this embodiment may be regarded as an axis of symmetry of the inductor 200V. Please note that the ETIMC architecture of the inductor 200V works when the aggressor coil (e.g. the neighboring coil) such as the aggressor coil Aggressor(1) shown in FIG. 5 (more specifically, the center of the aggressor coil Aggressor(1)) lies on the axis 401. For brevity, similar descriptions for this embodiment are not repeated in detail here.

According to some embodiments, when neglecting some minor differences of implementation details regarding layout (such as that due to a small gap between the terminals A and B and/or a small shift of one or more partial wirings), one of the two turns of the inductor 200 (e.g. the inductor 200V), such as a second turn corresponding to the closed loop version 100-2, may be regarded as a replication of the other (of the two turns) such as a first turn corresponding to the closed loop version 100-1.

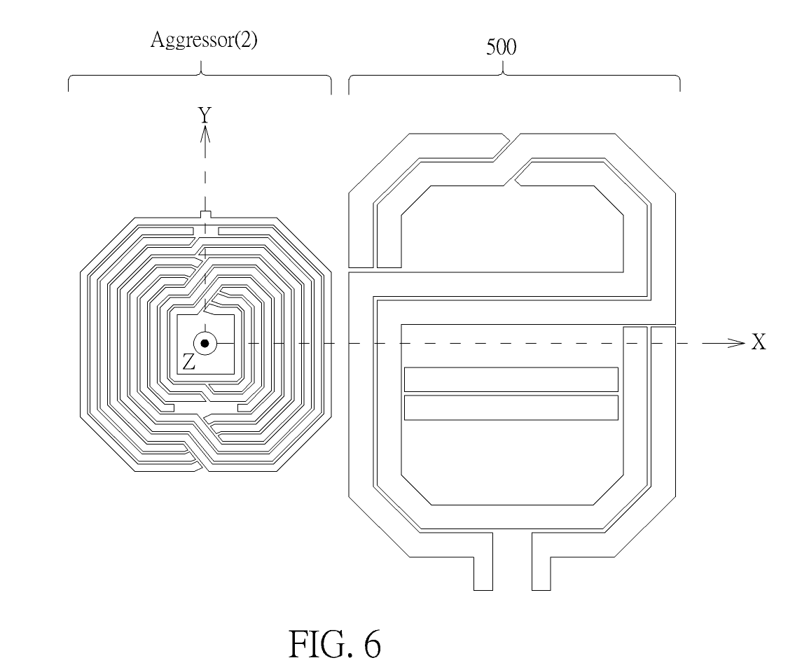

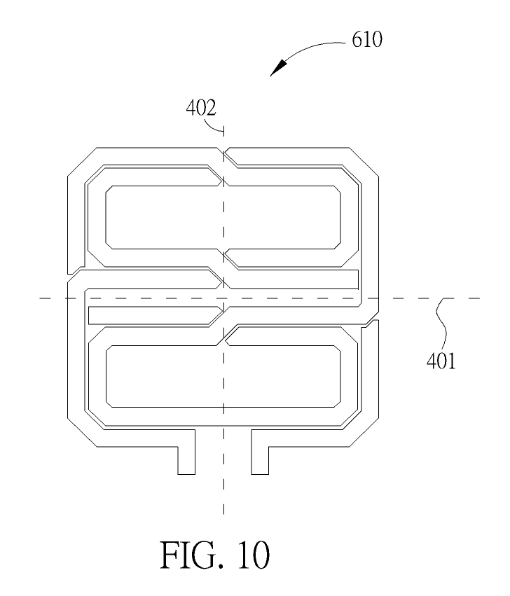

According to some of the following embodiments, implementation details regarding ETIMC inductor mask design such as some layout details of the inductor 200 are illustrated. For example, a first ETIMC inductor mask design of the embodiments respectively shown in FIG. 6 and FIGS. 7-9 may be regarded as the Layout Style I, and a second ETIMC inductor mask design of the embodiment shown in FIGS. 10-12 may be regarded as the Layout Style II.

FIG. 6 illustrates an EM simulation setup of an inductor 500 equipped with IMC architecture according to an embodiment of the present invention, where the inductor 500 shown in FIG. 6 can be taken as an example of the inductor 200 shown in FIG. 2. The IMC architecture of the inductor 500 is an ETIMC architecture. Similarly, the ETIMC architecture of the inductor 500 works when the aggressor coil (e.g. the neighboring coil) such as the aggressor coil Aggressor(2) shown in FIG. 6 (more specifically, the center of the aggressor coil Aggressor(2)) lies on the axis 401, which is aligned to the X-axis in this embodiment. For example, the aggressor coil Aggressor(2) may be adjacent to the inductor 500. For brevity, similar descriptions for this embodiment are not repeated in detail here.

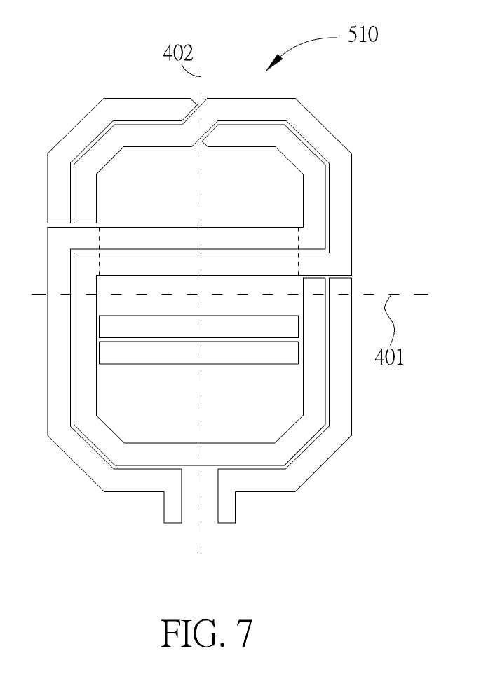

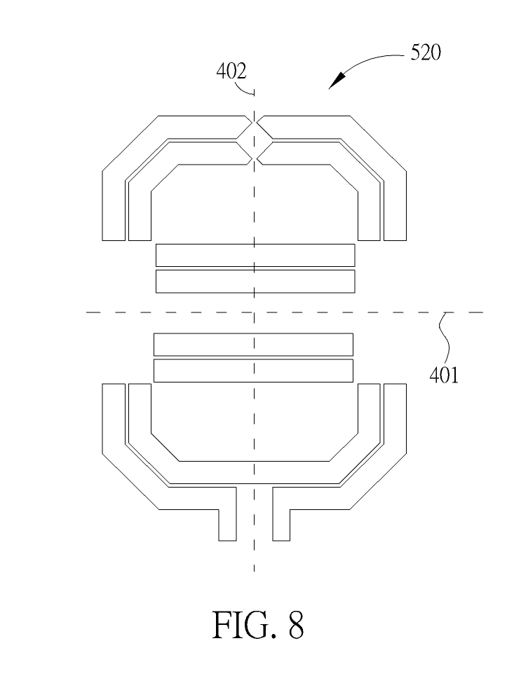

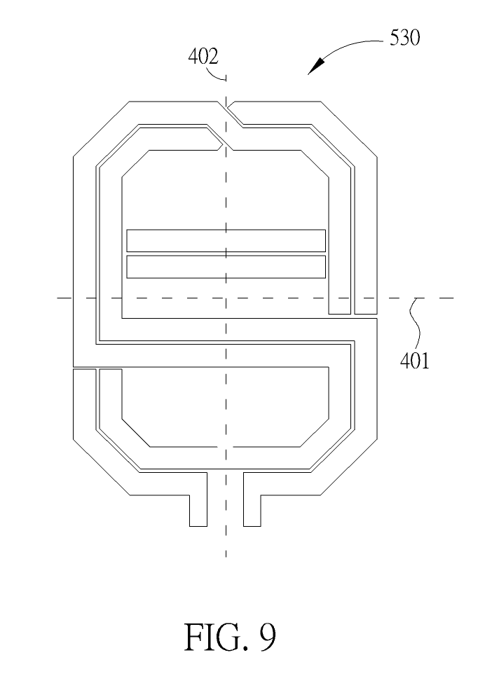

FIG. 7 illustrates a first layer 510 of the first ETIMC inductor mask design according to an embodiment of the present invention, FIG. 8 illustrates a second layer 520 of the first ETIMC inductor mask design, and FIG. 9 illustrates a third layer 530 of the first ETIMC inductor mask design. Each of the first layer 510, the second layer 520, and the third layer 530 may be implemented with at least one conductive material (e.g. metal, or any of other types of conductive materials) to provide conductive paths, and the partial structures or the sub-structures of their wirings (e.g. the segments of wirings/sub-wirings of these three layers) may be taken as an example of the plurality of partial wirings coupled between the first terminal A and the second terminal B. In addition, the third layer 530 may be implemented as the bottommost layer within these three layers, the second layer 520 may be implemented above the third layer 530, and the first layer 510 may be implemented above the second layer 520. As the first layer 510 and the second layer 520 are adjacent to each other, and as the second layer 520 and the third layer 530 are adjacent to each other, the conductive material (e.g. metal, etc.) of two or more layers of these three layers may be combined in overlapped regions (e.g. the overlapped regions of the two or more layers, such as the regions where the conductive material exists in the two or more layers). For brevity, similar descriptions for this embodiment are not repeated in detail here.

According to some embodiments, the order of these three layers may be reversed (e.g. the second layer 520 may be implemented above the first layer 510, and the third layer 530 may be implemented above the second layer 520). According to some embodiments, the second layer 520 may be implemented with through vias such as silicon vias (TSVs). For example, the vias may be distributed in the conductive material regions (e.g. the metal regions) of the second layer 520 shown in FIG. 8.

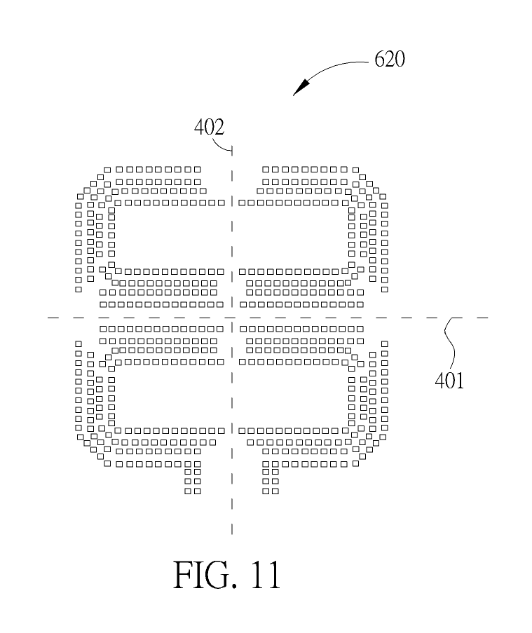

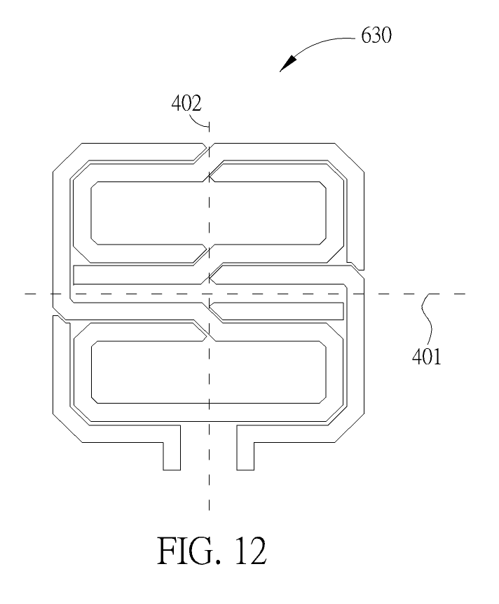

FIG. 10 illustrates a first layer 610 of the second ETIMC inductor mask design according to another embodiment of the present invention, FIG. 11 illustrates a second layer 620 of the second ETIMC inductor mask design, and FIG. 12 illustrates a third layer 630 of the second ETIMC inductor mask design. Each of the first layer 610, the second layer 620, and the third layer 630 may be implemented with at least one conductive material (e.g. metal, or any of other types of conductive materials) to provide conductive paths, and the partial structures or the sub-structures of their wirings (e.g. the segments of wirings/sub-wirings of these three layers) may be taken as an example of the plurality of partial wirings coupled between the first terminal A and the second terminal B. In addition, the third layer 630 may be implemented as the bottommost layer within these three layers, the second layer 620 may be implemented above the third layer 630, and the first layer 610 may be implemented above the second layer 620. As the first layer 610 and the second layer 620 are adjacent to each other, and as the second layer 620 and the third layer 630 are adjacent to each other, the conductive material (e.g. metal, etc.) of two or more layers of these three layers may be combined in overlapped regions. For brevity, similar descriptions for this embodiment are not repeated in detail here.

According to some embodiments, the order of these three layers may be reversed (e.g. the second layer 620 may be implemented above the first layer 610, and the third layer 630 may be implemented above the second layer 620).

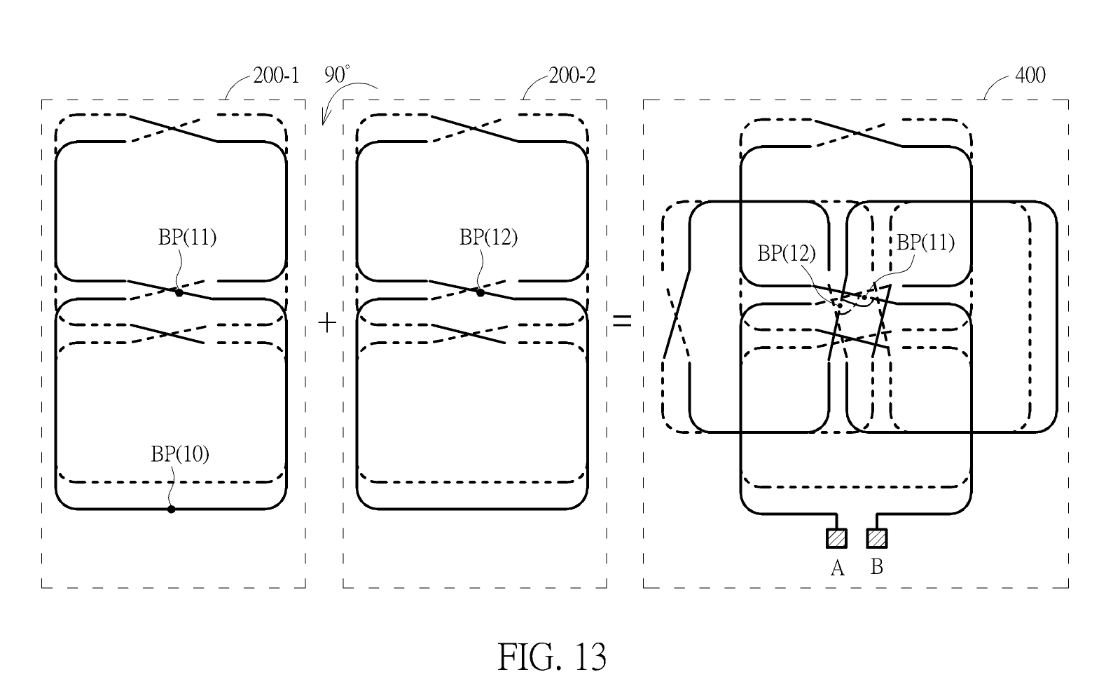

FIG. 13 is a diagram of an inductor 400 equipped with IMC architecture according to another embodiment of the present invention. For better comprehension, two closed loop versions 200-1 and 200-2 of the inductor 200 are illustrated, where each of the two closed loop versions 200-1 and 200-2 may be regarded as two turns, and some break points such as the break points BP(10), BP(11), BP(12), etc. may indicate that the loop(s)/turn(s) may be broken there. As shown in FIG. 13, the inductor 400 may be implemented by combining the two closed loop versions 200-1 and 200-2 of the inductor 200. Suppose that the closed loop version 200-1 of the inductor 200 may be broken at the break points BP(10) and BP(11) into two portions, such as a main portion comprising most of the partial wirings thereof (e.g. the portion of almost all of the partial wirings of the closed loop version 200-1 except the inverse-C shape portion between the break points BP(10) and BP(11)) and a secondary portion comprising the remaining partial wirings thereof (e.g. the inverse-C shape portion between the breakpoints BP(10) and BP(11)), and that the closed loop version 100-2 of the inductor 100 may be broken at the break point BP(12). The inductor 400 is equivalent to a combination of the main portion of the closed loop version 200-1, the closed loop version 200-2 that has been broken at the break point BP(12), and the secondary portion of the closed loop version 200-1. For example, a current path within the inductor 400 may start from the first terminal A and pass through the main portion integrated into the inductor 400 (e.g. starting from the lower end of the main portion at the break point BP(10) and reaching the other end of the main portion at the break point BP(11)), and may pass through the closed loop version 200-2 that has been broken at the break point BP(12) and is integrated into the inductor 400 (e.g. starting from one end at one side of the break point BP(12) and reaching the other end at the other side of the break point BP(12)), and may further pass through the secondary portion integrated into the inductor 400 (e.g. starting from the upper end of the inverse-C-shape portion at the break point BP(11) and reaching the lower end of the inverse-C-shape portion at the break point BP(10)) and reach the second terminal B.

The architecture shown in FIG. 13 may be regarded as an inductor architecture having even turns of inductor architecture, where the IMC architecture of the inductor 400 may be classified as the ETIMC architecture, and the inductor 400 equipped with the IMC architecture may be regarded as an ETIMC inductor. Please note that the inductor 400 is also applicable to an electronic device such as that mentioned above. For example, the inductor 400 may be applied to the IC in the electronic device, and the inductor 400 may be implemented as one of multiple components within the IC. Because of the ETIMC architecture, the inductor 400 can greatly reduce or cancel unwanted magnetic coupling due to a neighboring coil such as that mentioned above.

According to some embodiments, the IMC architecture of the inductor 400 may be referred to as the ETIMC architecture. In some embodiments, the IMC architecture of the inductor 400 may be referred to as the lucky-clover type (or lucky-leaf type) ETIMC architecture.

According to some embodiments, the inductor 200 may comprise a first turn of wirings (e.g. the closed loop version 100-1) and a second turn of wirings (e.g. the closed loop version 100-2). The first turn of wirings may comprise the first set of partial wirings 110, the second set of partial wirings 120, and the third set of partial wirings 130, and the second turn of wirings may comprise multiple sets of partial wirings that emulate the first set of partial wirings 110, the second set of partial wirings 120, and the third set of partial wirings within the first turn of wirings 130, respectively. For example, the first turn of wirings may be divided into two sub-turns (e.g. the inverse-S-shape portion and the S-shape portion of the closed loop version 100-1) ata break point of the first turn of wirings (e.g. the break point BP(1) of the closed loop version 100-1). The second turn of wirings (e.g. the closed loop version 100-2) may be inserted between one end of one of the two sub-turns at one side of the break point of the first turn (e.g. the upper end of the inverse-S-shape portion) and one end of the other of the two sub-turns at the other side of the breakpoint of the first turn (e.g. the upper end of the S-shape portion). In addition, the combination of the first turn of wirings and the second turn of wirings can provide a current path that starts from the first terminal A, passes through the one of the two sub-turns (e.g. the inverse-S-shape portion integrated into the inductor 200), the second turn of wirings (e.g. the closed loop version 100-2 that has been broken at the break point BP(2) and is integrated into the inductor 200), and the other of the two sub-turns (e.g. the S-shape portion integrated into the inductor 200), and reaches the second terminal B.

According to some embodiments, the inductor 400 may comprise a first group of wirings (e.g. the closed loop version 200-1) and a second group of wirings (e.g. the closed loop version 200-2). The first group of wirings may comprise the first turn of wirings (e.g. the closed loop version 100-1) and the second turn of wirings (e.g. the closed loop version 100-2), and the second group of wirings may comprise multiple turns of wirings that emulate the first turn of wirings and the second turn of wirings, respectively. For example, the first group of wirings may be divided into two sub-groups (e.g. the main portion and the secondary portion of the closed loop version 200-1) at a break point of the first group of wirings (e.g. the break point BP(11) of the closed loop version 200-1). The second group of wirings (e.g. the closed loop version 200-2) may be inserted between one end of one of the two sub-groups at one side of the break point of the first group (e.g. the upper end of the main portion) and one end of the other of the two sub-groups at the other side of the break point of the first group (e.g. the upper end of the secondary portion). In addition, the combination of the first group of wirings and the second group of wirings can provide a current path that starts from the first terminal A, passes through the one of the two sub-groups (e.g. the main portion integrated into the inductor 400), the second group of wirings (e.g. the closed loop version 200-2 that has been broken at the break point BP(12) and is integrated into the inductor 400), and the other of the two sub-groups (e.g. the secondary portion integrated into the inductor 400), and reaches the second terminal B.

The present invention inductor (e.g. the inductor 100, the inductor 200, the inductor 400, etc.) may be configured to reduce or cancel the EM interference due to the neighboring coil. For example, the present invention inductor may be configured to reduce or cancel the EM interference due to the neighboring coil, no matter where the neighboring coil is positioned. According to the embodiment shown in FIG. 3, the neighboring coil such as the aggressor coil Aggressor(1) is not positioned on a first axis (e.g. the axis 301) of the inductor 100 such as the inductor 100V. The first set of partial wirings 110 and the second set of partial wirings 120 are positioned at one side of the first axis (e.g. the side below the axis 301 shown in FIG. 3), and the third set of partial wirings 130 is positioned at another side of the first axis (e.g. the side above the axis 301 shown in FIG. 3). In addition, the first axis (e.g. the axis 301) is perpendicular to a second axis of the inductor 100 such as the inductor 100V (e.g. the axis 302). The first set of partial wirings 110 and a portion of the third set of partial wirings 130 are positioned at one side of the second axis (e.g. the left side of the axis 302), and the second set of partial wirings 120 and another portion of the third set of partial wirings 130 are positioned at another side of the second axis (e.g. the right side of the axis 302). According to the embodiment shown in FIG. 4, the neighboring coil such as the aggressor coil Aggressor(1) is positioned on an axis of the inductor 100 such as the inductor 100V (e.g. the axis 302). The first set of partial wirings 110 and a portion of the third set of partial wirings 130 are positioned at one side of the axis (e.g. the left side of the axis 302), and the second set of partial wirings 120 and another portion of the third set of partial wirings 130 are positioned at another side of the axis (e.g. the right side of the axis 302). According to the embodiment shown in FIG. 5, the neighboring coil such as the aggressor coil Aggressor(1) is positioned on an axis of the inductor 200 such as the inductor 200V (e.g. the axis 401), and the axis passes through the center of the inductor (e.g. the center of symmetry thereof). For example, the inductor 200 such as the inductor 200V may comprise the multiple sets of partial wirings that emulate the first set of partial wirings 110, the second set of partial wirings 120, and the third set of partial wirings 130 within the first turn of wirings, respectively. The combination of the first set of partial wirings 110, the second set of partial wirings 120, and the third set of partial wirings 130 (e.g. the closed loop version 100-1 integrated into the inductor 200) and the combination of the multiple sets of partial wirings (e.g. the closed loop version 100-2 integrated into the inductor 200) are both centered at the center of the inductor, with opposite arrangement directions, respectively, where the combination of the multiple sets of partial wirings corresponds to 180-degree rotation of the combination of the first set of partial wirings 110, the second set of partial wirings 120, and the third set of partial wirings 130. For example, the closed loop versions 100-1 and 100-2 integrated into the inductor 200 are both centered at the center of symmetry of the inductor 200, and the arrangement directions of the closed loop versions 100-1 and 100-2 are opposite to each other.

Some embodiments of the present invention provide an apparatus for performing magnetic-cancelling, where the apparatus is applicable to the electronic device. The apparatus may comprise the present invention inductor (e.g. the inductor 100, the inductor 200, the inductor 400, etc.). In addition, the apparatus may comprise at least one portion (e.g. a portion or all) of the electronic device. For example, the apparatus may comprise the circuit of the electronic device. For another example, the apparatus may comprise the whole of the electronic device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An inductor equipped with imbalanced magnetic-cancelling (IMC) architecture, the inductor being applicable to an electronic device, the inductor comprising:
a first terminal, arranged to couple the inductor to a terminal of a circuit of the electronic device;
a second terminal, arranged to couple the inductor to another terminal of the circuit of the electronic device;
a plurality of partial wirings, coupled between the first terminal and the second terminal, wherein the plurality of partial wirings comprises:
a first set of partial wirings, coupled in series, wherein the first set of partial wirings is coupled to the first terminal of the inductor;
a second set of partial wirings, coupled in series, wherein the second set of partial wirings is coupled to the second terminal of the inductor; and
a third set of partial wirings, coupled in series, wherein the third set of partial wirings is coupled between the first set of partial wirings and the second set of partial wirings;
wherein a second area enclosed by the first set of partial wirings and the second set of partial wirings is different from a first area enclosed by the third set of partial wirings, to provide the inductor with the IMC architecture.

2. The inductor of claim 1, wherein one end of the first set of partial wirings is connected to the first terminal of the inductor; and one end of the second set of partial wirings is connected to the second terminal of the inductor.

3. The inductor of claim 2, wherein the third set of partial wirings is coupled between another end of the first set of partial wirings and another end of the second set of partial wirings.

4. The inductor of claim 1, wherein the inductor comprises:
a first turn of wirings, wherein the first turn of wirings comprises the first set of partial wirings, the second set of partial wirings, and the third set of partial wirings; and
a second turn of wirings, wherein the second turn of wirings comprises multiple sets of partial wirings that emulate the first set of partial wirings, the second set of partial wirings, and the third set of partial wirings within the first turn of wirings, respectively.

5. The inductor of claim 4, wherein the first turn of wirings is divided into two sub-turns at a break point of the first turn of wirings; and the second turn of wirings is inserted between one end of one of the two sub-turns at one side of the break point of the first turn and one end of the other of the two sub-turns at the other side of the breakpoint of the first turn.

6. The inductor of claim 5, wherein a combination of the first turn of wirings and the second turn of wirings provides a current path that starts from the first terminal, passes through the one of the two sub-turns, the second turn of wirings, and the other of the two sub-turns, and reaches the second terminal.

7. The inductor of claim 4, wherein the inductor comprises:
a first group of wirings, wherein the first group of wirings comprises the first turn of wirings and the second turn of wirings;
a second group of wirings, wherein the second group of wirings comprises multiple turns of wirings that emulate the first turn of wirings and the second turn of wirings, respectively.

8. The inductor of claim 7, wherein the first group of wirings is divided into two sub-groups at a break point of the first group of wirings; and the second group of wirings is inserted between one end of one of the two sub-groups at one side of the break point of the first group and one end of the other of the two sub-groups at the other side of the break point of the first group.

9. The inductor of claim 8, wherein a combination of the first group of wirings and the second group of wirings provides a current path that starts from the first terminal, passes through the one of the two sub-groups, the second group of wirings, and the other of the two sub-groups, and reaches the second terminal.

10. The inductor of claim 1, wherein the inductor is configured to reduce or cancel electromagnetic (EM) interference due to a neighboring coil.

11. The inductor of claim 10, wherein the inductor is configured to reduce or cancel the EM interference due to the coil, no matter where the coil is positioned.

12. The inductor of claim 10, wherein the coil is not positioned on a first axis of the inductor; and the first set of partial wirings and the second set of partial wirings are positioned at one side of the first axis, and the third set of partial wirings is positioned at another side of the first axis.

13. The inductor of claim 12, wherein the first axis is perpendicular to a second axis of the inductor; and the first set of partial wirings and a portion of the third set of partial wirings are positioned at one side of the second axis, and the second set of partial wirings and another portion of the third set of partial wirings are positioned at another side of the second axis.

14. The inductor of claim 10, wherein the coil is positioned on an axis of the inductor; and the first set of partial wirings and a portion of the third set of partial wirings are positioned at one side of the axis, and the second set of partial wirings and another portion of the third set of partial wirings are positioned at another side of the axis.

15. The inductor of claim 10, wherein the coil is positioned on an axis of the inductor, and the axis passes through a center of the inductor; the inductor further comprises multiple sets of partial wirings that emulate the first set of partial wirings, the second set of partial wirings, and the third set of partial wirings, respectively; and a combination of the first set of partial wirings, the second set of partial wirings, and the third set of partial wirings and a combination of the multiple sets of partial wirings are both centered at the center of the inductor, with opposite arrangement directions, respectively.

16. The inductor of claim 15, wherein the combination of the multiple sets of partial wirings corresponds to 180-degree rotation of the combination of the first set of partial wirings, the second set of partial wirings, and the third set of partial wirings.

17. The inductor of claim 10, wherein the coil is adjacent to the inductor.

18. An apparatus for performing magnetic-cancelling, the apparatus being applicable to an electronic device, the apparatus comprising:
an inductor equipped with imbalanced magnetic-cancelling (IMC) architecture, the inductor comprising:
a first terminal, arranged to couple the inductor to a terminal of a circuit of the electronic device;
a second terminal, arranged to couple the inductor to another terminal of the circuit of the electronic device;
a plurality of partial wirings, coupled between the first terminal and the second terminal, wherein the plurality of partial wirings comprises:
a first set of partial wirings, coupled in series, wherein the first set of partial wirings is coupled to the first terminal of the inductor;
a second set of partial wirings, coupled in series, wherein the second set of partial wirings is coupled to the second terminal of the inductor; and
a third set of partial wirings, coupled in series, wherein the third set of partial wirings is coupled between the first set of partial wirings and the second set of partial wirings;
wherein a second area enclosed by the first set of partial wirings and the second set of partial wirings is different from a first area enclosed by the third set of partial wirings, to provide the inductor with the IMC architecture.

19. The apparatus of claim 18, wherein one end of the first set of partial wirings is connected to the first terminal of the inductor; and one end of the second set of partial wirings is connected to the second terminal of the inductor.

20. The apparatus of claim 19, wherein the third set of partial wirings is coupled between another end of the first set of partial wirings and another end of the second set of partial wirings.
